(19) United States
(12) Patent Application Publication
(10) Pub. No.: US 2013/0256407 A1
(43) Pub. Date: Oct. 3, 2013

(54) WIRELESS 2D BARCODE COMMUNICATION CONNECTION METHOD

(71) Applicants: AIBELIVE CO., LTD., Taipei City (TW); FLYFISH HOLDINGS LIMITED, British Virgin Islands (GB)

(72) Inventors: Chen-Wei SU, Taipei City (TW); Chun-Ping FANG, Taipei City (TW)

(73) Assignees: FLYFISH HOLDINGS LIMITED, British Virgin Islands (GB); AIBELIVE CO., LTD., Taipei City (TW)

(21) Appl. No.: 13/772,956

(22) Filed: Feb. 21, 2013

(30) Foreign Application Priority Data
Mar. 27, 2012 (TW) 101110601

(51) Int. Cl. G06K 5/00; G06K 19/06

(52) U.S. Cl. CPC G06K 5/00; G06K 19/06037
USPC 235/382

(57) ABSTRACT

A wireless 2D barcode communication connection method for allowing communication between a handheld device and an electronic device via a wireless access point by: enabling the electronic device to encode and convert the data of the name of the wireless access point, password, encryption and information of the electronic device into a 2D barcode image and to display the 2D barcode image on a display screen so that the handheld device can drive an image capture module thereof to catch the 2D barcode image and a processor thereof to process and decode the 2D barcode image into the original text string data containing the name of the wireless access point, password, encryption and information of the electronic device by which the handheld device can connect to the electronic device via the wireless access point.

This application claims the priority benefit of Taiwan patent application number 101110601, filed on Mar. 27, 2012.

### BACKGROUND OF THE INVENTION

1. Field of the Invention

The present invention relates to communication technology and more particularly, to a wireless 2D barcode communication connection method, which allows an electronic device to provides the name of its wireless access point, password, encryption and information to a handheld device wirelessly by means of a 2D barcode, enabling the handheld device to connect to the wireless access point and to further establish communication with the electronic device.

2. Description of the Related Art

Continuous functional improvement of handheld devices brings great convenience to human life. Under the rapid pace of life today, in case of an emergency, one person can communicate with another at a remote place using a handheld device. Further, most people may suffer from lack of time in life. Many people may travel abroad frequently due to their job nature or work environment. Under these conditions, manufacturers keep creating telecommunication network technology for handheld devices. Nowadays, 3G and 4G networks have been available, allowing people to talk anywhere via a handheld device, to send a short message through a handheld device, or to connect a handheld device to the Internet.

Further, the widespread use of smart phone encourages creation of a variety of application software programs. You can see handheld devices doing different things in different places in our life. These smart phone application software programs allow connection to the Internet. Thus, people can use a handheld device to send e-mails, communicate with friends, search web data or record things when taking a transportation vehicle, walking or waiting for a bus. Further, when going outside, people can use a handheld device to query a search engine to get route, transportation, restaurant, movie, exhibition and many other information or data. However, due to network bandwidth limitations, the flow rate is constrained. Provides need to spend a lot of time and capital to upgrade their installations regularly. Users may frequently encounter the problem of low internet speed or internet traffic jams.

Nowadays, internet access technology for computer has been changed from early Ethernet cable connection to modern wireless connection through a wireless access point. A wireless access point allows a handheld device to connect to the internet or to communicate with other internet devices wirelessly without any network cable line. Wireless access points have been established everywhere around us. Due to the advent of wireless internet connections and wireless access points, people may use a handheld device at a particular place (office, home, transportation station, etc.) to connect to a wireless access point for high speed internet transmission. However, when using a handheld device at a different place, the name of the wireless access point, password and encryption may be changed. In this case, the user shall have to manually alter the settings of the handheld device for wireless network operation. If the user cannot remember the related connection data, wireless network operation will not work. Further, when using a handheld device to connect to a computer through a wireless network, an extra setting operation is necessary. This setting operation is complicated, bothering the user. If the user is not familiar with this setting operation, the connection cannot be achieved. Improvement in this regard is strongly desired.

### SUMMARY OF THE INVENTION

The present invention has been accomplished under the circumstances in view. It is therefore the main object of the present invention to provide a wireless 2D barcode communication connection method, which allows wireless communication between a handheld device and an electronic device via a wireless access point, avoiding communication problem between the handheld device and the electronic device due to forgotten connection data and facilitating quick connection.

To achieve this and other objects of the present invention, a wireless 2D barcode communication connection method for allowing wireless communication between a handheld device and an electronic device via a wireless access point is performed by: enabling the electronic device to encode and convert the data of the name of the wireless access point, password, encryption and information of the electronic device into a 2D barcode image and to display the 2D barcode image on a display screen so that the handheld device can drive an image capture module thereof to catch the 2D barcode image and a processor thereof to process and decode the 2D barcode image into the original text string data containing the name of the wireless access point, password, encryption and information of the electronic device by which the handheld device can connect to the electronic device via the wireless access point.

Further, after the processor of the handheld device processed and decoded the 2D barcode image into the original text string data, the processor of the handheld device will determine the current operation mode to be an auto (active) connection mode or manual (passive) connection mode. If the current operation mode is an auto (active) connection mode, the processor of the handheld device will connect to the wireless access point subject to the text string data. If the current operation mode is a manual (passive) connection mode, the display screen of the handheld device will display “access point name” column and “password” column for filling in by the user by hand. Thereafter, the processor can connect to the wireless access point through the wireless transceiver module subject to the keyed-in data, and then connect to the electronic device by means of the wireless transceiver module and the wireless access point subject to the information of the electronic device contained in the text string data. Thus, the wireless 2D barcode communication connection method is applicable to any of a variety of handheld devices.

### BRIEF DESCRIPTION OF THE DRAWINGS

FIG. 1 is a circuit block diagram of a wireless 2D barcode communication connection method in accordance with the present invention.

FIG. 2 is an operational flow chart of the wireless 2D barcode communication connection method in accordance with the present invention (I).

FIG. 3 is an operational flow chart of the wireless 2D barcode communication connection method in accordance with the present invention (II).

FIG. 4 is a schematic applied view of the present invention, illustrating a 2D barcode image displayed on the electronic device.

FIG. 5 is a schematic applied view of the present invention, illustrating the handheld device captured the 2D barcode image.

### DETAILED DESCRIPTION OF THE PREFERRED EMBODIMENT

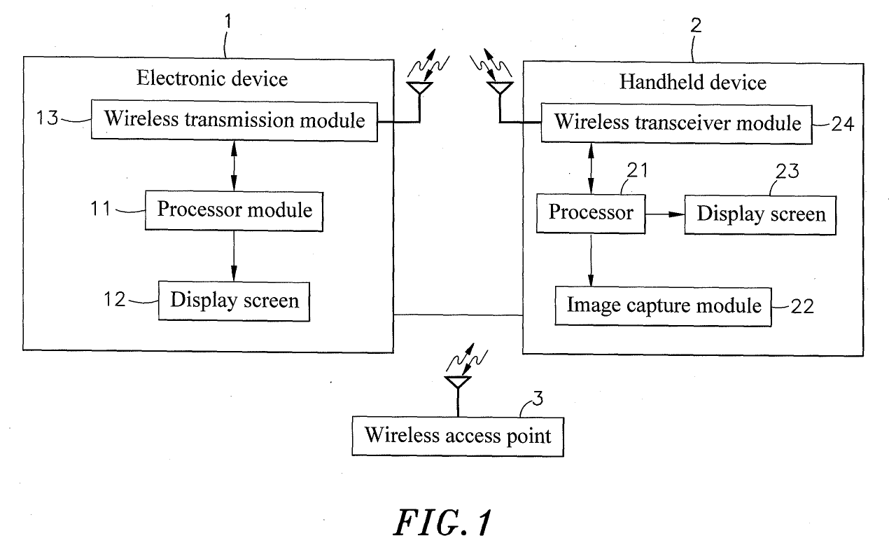

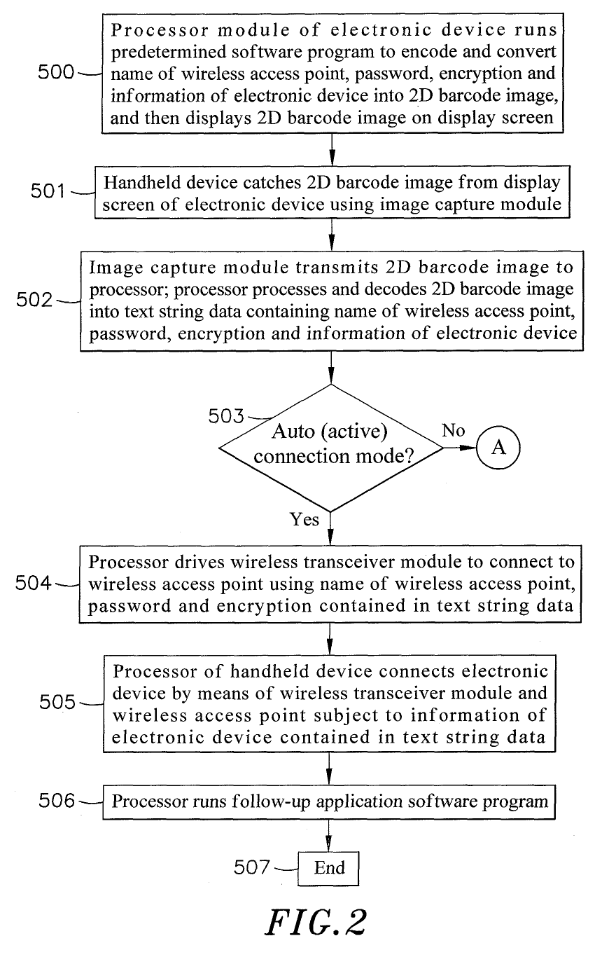

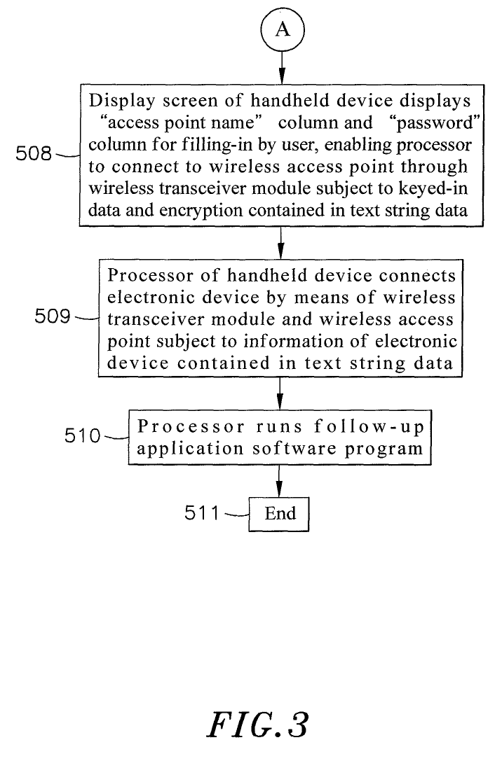

Referring to FIGS. 1-3, a wireless 2D barcode communication connection method in accordance with the present invention is adapted for allowing wireless communication between an electronic device 1 and a handheld device 2 via a wireless access point 3.

The electronic device 1 comprises a processor module 11, a display screen 12 and a wireless transmission module 13. The display screen 12 and the wireless transmission module 13 are respectively electrically coupled to the processor module 11.

The handheld device 2 comprises a processor 21, an image capture module 22, a display screen 23, and a wireless transceiver module 24. The image capture module 22, the display screen 23 and the wireless transceiver module 24 are respectively electrically coupled to the processor 21.

The wireless access point 3 can be linked with the wireless transmission module 13 of the electronic device 1 and the wireless transceiver module 24 of the handheld device 2 wirelessly. The structural design of component parts of the wireless access point 3 and its wireless linking method are of the known art, and hence no further detailed description in this regard will be necessary.

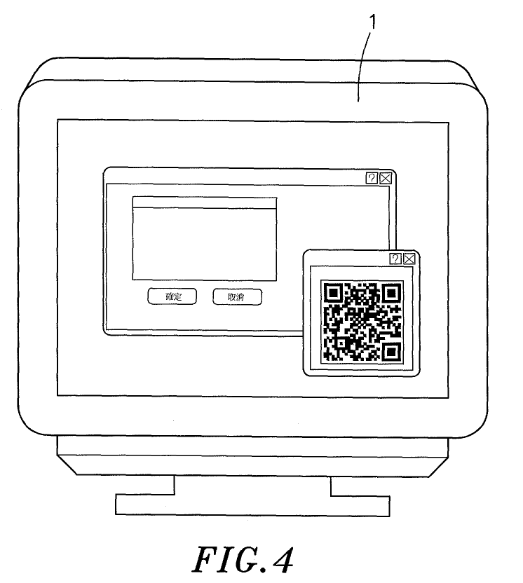

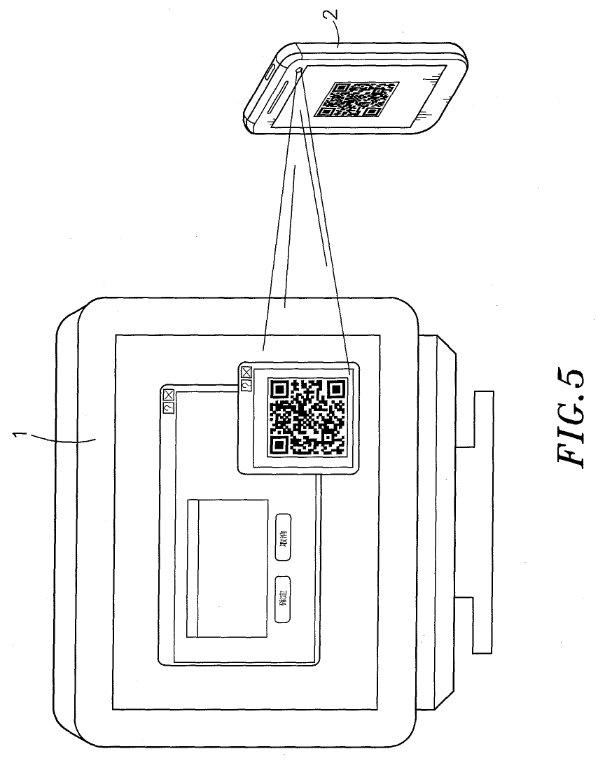

Referring to FIGS. 4 and 5, and FIGS. 1-3 again, when the electronic device 1, the handheld device 2 and the wireless access point 3 are started, the handheld device 2 can be connected to a telecommunication network by means of the wireless transceiver module 24, and the electronic device 1 can be connected to the wireless access point 3 by means of the wireless transmission module 13. At this time, the wireless transceiver module 2 can be communicated with the electronic device 1 by means of a 2D barcode via the wireless access point 3 subject to the following steps:
(500) The processor module 11 of the electronic device 1 runs a predetermined software program to encode and convert a pre-stored data of the name of the wireless access point 3, password, encryption and information of the electronic device 1 into a 2D barcode image, and then displays the 2D barcode image on the display screen 12.
(501) The handheld device 2 drives the image capture module 22 to catch the 2D barcode image displayed by the display screen 12.
(502) The image capture module 22 of the handheld device 2 transmits the 2D barcode image to the processor 21, and the processor 21 processes and decodes the 2D barcode image, thereby obtaining a text string data containing the name of the wireless access point 3, password, encryption and information of the electronic device 1.
(503) The processor 21 of the handheld device 2 determines whether or not the current operation mode is an auto (active) connection mode. And then, the processor 21 proceeds to step (504) if positive, or step (508) if negative.
(504) The processor 21 drives the wireless transceiver module 24 to connect to the wireless access point 3 using the name of the wireless access point 3, password and encryption contained in the text string data.
(505) The processor 21 of the handheld device 2 connects to the electronic device 1 by means of the wireless transceiver module 24 and the wireless access point 3 subject to the information of the electronic device 1 contained in the text string data.
(506) The processor 21 of the handheld device 2 runs the follow-up application software program.
(507) End.
(508) The display screen 23 of the handheld device 2 displays “access point name” column and “password” column for filling in by the user by hand, enabling the processor 21 to connect to the wireless access point 3 through the wireless transceiver module 24.
(509) The processor 21 of the handheld device 2 connects to the electronic device 1 by means of the wireless transceiver module 24 and the wireless access point 3 subject to the information of the electronic device 1 contained in the text string data
(510) The processor 21 of the handheld device 2 runs the follow-up application software program.
(511) End.

From the steps described above, it can be known that, prior to connection between the electronic device 1 and the handheld device 2 by 2D barcode communication, the handheld device 2 is connected to the telecommunication network by means of the wireless transceiver module 24, and the electronic device 1 is connected to the wireless access point 3 by means of the wireless transmission module 13. The method of connecting the handheld device 2 to the telecommunication network and the method of connecting the electronic device 1 to the wireless access point 3 are of the known art and not within the scope of the present invention, and hence no further detailed description in this regard will be necessary. At this time, the electronic device 1 and the wireless access point 3 cannot be connected to the telecommunication network, and therefore, the handheld device 2, the electronic device 1 and the wireless access point 3 are not linked. At this time, the processor module 11 of the electronic device 1 can be controlled to run a predetermined software program, encoding and converting a pre-stored connection data containing the name of the wireless access point 3, password, encryption and information of the electronic device 1 into a 2D barcode image and then displays the 2D barcode image on the display screen 12.

At this time, the user needs only to aim the image capture module 22 of the handheld device 2 at the 2D barcode image displayed on the display screen 12 of the electronic device 1, enabling the image capture module 22 to catch the 2D barcode image and to transmit the 2D barcode image to the processor 21, which in turn processes and decodes the 2D barcode image into a text string data. Thereafter, the processor 21 determines the operation mode to be an auto (active) connection mode or manual (passive) connection mode. In case of auto (active) connection mode, the processor 21 of the handheld device 2 connects to the wireless access point 3 subject to the name of the wireless access point 3, password and encryption contained in the text string data. In case of manual (passive) connection mode, the display screen 23 of the handheld device 2 will display “access point name” column and “password” column for filling in by the user by hand, enabling the processor 21 to connect to the wireless access point 3 through the wireless transceiver module 24 subject to the filled-in data. When the handheld device 2 and the wireless access point 3 are linked, the processor 21 of the handheld device 2 connects the electronic device 1 by means of the wireless transceiver module 24 and the wireless access point 3 automatically subject to the information of the electronic device 1 contained in the text string data. At this time, the handheld device 2 enters the domain of the electronic device 1. Thereafter, the processor 21 runs the follow-up application software program, allowing transmission of data or instructions between the electronic device 1 and the handheld device 2.

Further, the aforesaid electronic device 1 can be a desk computer, TV, tablet computer or notebook. The handheld device 2 can be a cell phone, smart phone, PDA, tablet computer, or any of a variety of other mobile communication devices. Further, the telecommunication network connected by the handheld device 2 can be 3G network or 4G network. Further, the 2D barcode can be PDF417, Data Matrix, MaxiCode symbol format, or most preferably, QR Code symbol format.

If QR Code symbol format is selected, the electronic device 1 encodes and converts the name of the wireless access point 3, password, encryption and information of the electronic device 1 into a 2D barcode image. During this step, the text string data of the name of the wireless access point 3, password, encryption and information of the electronic device 1 is divided into segments and analyzed, and then encoded with an ECC (Error Correction Code) encoding algorithm. Thereafter, the QR Code image size is determined subject to the binary value of the string length. At final, the binary value is filled in the image, and thus, the desired QR Code image is obtained after the mask is added. When the handheld device 2 processes and decodes the QR Code image, it is to binarize the image, and then to allocate the finder pattern, and then rotate and correct the image, and then to detect the presence of an alignment pattern and determine the model, and then to detect the presence of a timing pattern for dividing the QR Code image, and then to read out the mask data and remove the mask, and finally to read out and decode the binary text string, thereby obtaining the original text string data.

During actual application of the wireless 2D barcode communication connection method, the handheld device 2 is operated to get the 2D barcode image displayed on the display screen 12 of the electronic device 1, enabling the image to be processed and decoded into a text string data containing the name of the wireless access point 3, password, encryption and information of the electronic device 1 by which the handheld device 2 can be linked to the electronic device 1 via the wireless access point 3, avoiding communication problem between the handheld device 2 and the electronic device 1 due to forgotten connection data, and facilitating quick connection.

Further, after processed and decoded the captured image into a text string data, the processor 21 determines the operation mode to be an auto (active) connection mode or manual (passive) connection mode. In case of auto (active) connection mode, the handheld device 2 will connect to the wireless access point 3 subject to the name of the wireless access point 3, password and encryption contained in the text string data. In case of manual (passive) connection mode, the display screen 23 of the handheld device 2 will display “access point name” column and “password” column for filling in by the user by hand, enabling the processor 21 to connect to the wireless access point 3 through the wireless transceiver module 24 subject to the filled-in data. Because different brands, models or types of handheld devices 2 have different internal systems and setting methods, the invention employs the step of determining the operation mode to an auto (active) connection mode or manual (passive) connection mode, enabling different brands, models or types of handheld devices 2 to be connectable to the electronic device 1 via the wireless access point 3. Thus, even a handheld device simply provides a manual (passive) connection mode, it can still automatically catch the necessary data to establish connection with the electronic device.

In conclusion, the invention provides a wireless 2D barcode communication connection method for allowing communication between a handheld device 2 and an electronic device 1 via a wireless access point 3, wherein the electronic device 1 encodes and converts the data of the name of the wireless access point 3, password, encryption and information of the electronic device 1 into a 2D barcode image and displays the 2D barcode image on the display screen 12 thereof so that the handheld device 2 can drive the image capture module 22 to catch the 2D barcode image and the processor 21 to process and decode the 2D barcode image into the original text string data containing the name of the wireless access point 3, password, encryption and information of the electronic device 1 by which the handheld device 2 can connect to the electronic device 1 via the wireless access point 3.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A wireless 2D barcode communication connection method for allowing wireless communication between an electronic device and a handheld device via a wireless access point, wherein said electronic device comprises a processor module, a display screen and a wireless transmission module; said handheld device comprises a processor, an image capture module, a display screen and a wireless transceiver module, the wireless 2D barcode communication connection method comprising the steps of:
(A01) said processor module of said electronic device running a predetermined software program to encode and convert a pre-stored data of the name of said wireless access point, password, encryption and information of said electronic device into a 2D barcode image and to display said 2D barcode image on the display screen of said electronic device;
(A02) said handheld device driving said image capture module to catch said 2D barcode image displayed by said display screen;
(A03) said image capture module of said handheld device transmitting said 2D barcode image to the processor of said handheld device, enabling said processor of said handheld device to process and decode said 2D barcode image into a text string data containing the name of said wireless access point, password, encryption and information of said electronic device;
(A04) said processor of said handheld device driving said wireless transceiver module to connect to said wireless access point subject to the text string data containing the name of said wireless access point, password, encryption and information of said electronic device;
(A05) said processor of said handheld device connecting to said electronic device by means of said wireless transceiver module and said wireless access point subject to the information of said electronic device contained in said text string data. (A06) said processor of said handheld device running the follow-up application software program; and
(A07) ending the wireless 2D barcode communication connection

2. The wireless 2D barcode communication connection method as claimed in claim 1, further comprising a first sub step to be performed after step (A03) and prior to step (A04) where said processor of said handheld device determines the current operation mode to be an auto (active) connection mode or manual (passive) connection mode, and then said processor proceeds to step (A04) if the current operation mode is an au auto (active) connection mode, or a second sub step, if the current operation mode is a manual (passive) connection mode, said display screen of said handheld device displays “access point name” column and “password” column for filling in by the user by hand for enabling said processor to connect to said wireless access point through said wireless transceiver module subject to the keyed-in data and then to connect to said electronic device by means of said wireless transceiver module and said wireless access point subject to said information of said electronic device contained in said text string data.

3. The wireless 2D barcode communication connection method as claimed in claim 1, wherein said electronic device is selected from the group of desk computers, televisions, tablet computers and notebook computers.

4. The wireless 2D barcode communication connection method as claimed in claim 1, wherein said handheld device is selected from the group of mobile phones, smart phones, PDAs and tablet computers; said telecommunication network is one of 3G and 4G networks.

5. The wireless 2D barcode communication connection method as claimed in claim 1, wherein said 2D barcode is one of PDF417, Data Matrix, MaxiCode symbol format, and QR Code symbol formats.
